(19) United States
(12) Patent Application Publication
(10) Pub. No.: US 2024/0114531 A1
(43) Pub. Date: Apr. 4, 2024

(54) MANAGING MULTICAST AND BROADCAST SERVICES ON SEMI-PERSISTENT SCHEDULING RADIO RESOURCES

(71) Applicant: GOOGLE LLC, Mountain View, CA (US)

(72) Inventors: Chih-Hsiang Wu, Taoyuan City (TW); Kao-Peng Chou, Taoyuan City (TW)

(21) Appl. No.: 18/285,262

(22) PCT Filed: Mar. 30, 2022
(86) PCT No.: PCT/US22/22456

§ 371 Date: Oct. 2, 2023

Related U.S. Application Data
(60) Provisional application No. 63/169,670, filed on Apr. 1, 2021.

(51) Int. Cl. H04W 72/30; H04W 72/11

(52) U.S. Cl. CPC H04W 72/30; H04W 72/11; H04W 4/06

(57) ABSTRACT

A base station can implement a method for managing transmission of multicast and/or broadcast services (MBS) using semi-persistent scheduling (SPS). The method includes: transmitting (1702), to a user equipment (UE), a configuration for receiving MBS data on SPS radio resources; providing (1704), to the UE, an indication to activate receiving the MBS data in accordance with the configuration; and transmitting (1706), to the UE, the MBS data in accordance with the configuration.

### FIELD OF THE DISCLOSURE

This disclosure relates to wireless communications and, more particularly, to enabling setup and/or release of semi-persistent scheduling (SPS) radio resources for transmission and/or reception of one or more multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure plural UEs with a common frequency resource (CFR) and a physical downlink control channel (PDCCH) configuration configuring a group common PDCCH. The base station can assign a group common radio network temporary identifier (RNTI) to these UEs to receive physical downlink shared channel (PDSCH) transmissions including MBS data packet(s). Then the base station can send a downlink control information (DCI) with a cyclic redundancy check (CRC) scrambled by the group common RNTI on a group common PDCCH to schedule a PDSCH transmission including MBS data packet(s).

Recently, 3GPP has proposed transmitting MBS data via semi-persistent scheduling (SPS) resources. However, it is not clear how a base station is to configure and manage SPS radio resources for transmitting MBS data.

### SUMMARY

A base station and/or a UE can implement the techniques of this disclosure for managing transmission and reception of MBS using SPS. In particular, a base station can transmit, to the UE, a configuration for receiving MBS data on SPS radio resources (i.e., an MBS SPS configuration). The base station can transmit the configuration to the UE on dedicated resources for the UE, or can multicast or broadcast the configuration to multiple UEs.

The base station also provides, to the UE, an indication to activate receiving the MBS data in accordance with the configuration. In some implementations, receipt of the configuration itself activates the UE. For example, the configuration may include an integrated information element or field that causes the UE to activate the SPS radio resources for receiving the MBS data. In other implementations, the base station transmits the indication and the configuration to the UE separately yet in the same message (e.g., in an RRC message, such as an RRC reconfiguration message). In yet other implementations, the base station transmits the configuration and the indication to the UE in separate messages. For example, the base station may transmit the indication as a command to activate receiving the MBS data in accordance with the configuration. Similar to the configuration, the base station can transmit the command either using unicast transmissions to individual UEs or using multicast or broadcast transmissions to multiple UEs. After activating the UE, the base station transmits the MBS data in accordance with the configuration.

Within either the command or the configuration, the base station can indicate resources on which the UE should transmit acknowledgements to the command and/or the MBS data. For example, if the base station transmits a particular configuration to a UE in a unicast transmission, the base station can include within the particular configuration a HARQ resources configuration for the UE to transmit the acknowledgements. For example, the HARQ resources configuration can include time slots, frequency resources, and/or physical uplink control channel (PUCCH) format.

The command that the base station transmits (i.e., an MBS SPS activation command) may be in a different format than a command to activate receiving unicast data using SPS radio resources (i.e., a unicast SPS activation command). Alternatively, the MBS SPS activation command and the unicast SPS activation command may have the same format, but include different values of an SPS configuration index (also called an “SPS index” throughout this document). Further, the UE can determine whether a command is an MBS SPS activation command or a unicast SPS activation command based on a radio network temporary identifier (RNTI) that descrambles a cyclic redundancy check (CRC) received with the command, or scrambles a CRC computed from the command. For example, the base station can transmit an MBS SPS activation command with a CRC scrambled using an RNTI associated with MBS (e.g., a group RNTI), rather than an RNTI for the individual UE (e.g., a cell RNTI (c-RNTI)).

One example embodiment of these techniques is a method implemented in a base station for managing transmission of multicast and/or broadcast services (MBS) using semi-persistent scheduling (SPS). The method can be executed by processing hardware and includes: transmitting, to a user equipment (UE), a configuration for receiving MBS data on SPS radio resources. The method further includes providing, to the UE, an indication to activate receiving the MBS data in accordance with the configuration and transmitting, to the UE, the MBS data in accordance with the configuration.

Another example embodiment of these techniques is a base station including processing hardware and configured to implement the method above.

A further example embodiment of these techniques is a method in a UE for managing reception of MBS using SPS. The method can be executed by processing hardware and includes receiving, from a base station, a configuration for receiving MBS data on SPS resources. The method further includes determining that the UE is to activate receiving the MBS data in accordance with the configuration and receiving, from the base station, the MBS data in accordance with the configuration.

Yet another example embodiment of these techniques is a UE including processing hardware and configured to implement the method above.

### BRIEF DESCRIPTION OF THE DRAWINGS

FIG. 1A is a block diagram of an example wireless communication system in which a RAN and/or a UE implement the techniques of this disclosure for managing transmission and reception of MBS;

FIG. 1B is a block diagram of an example base station including a central unit (CU) and a distributed unit (DU) that can operate in the system of FIG. 1A;

FIG. 2 is a block diagram of an example protocol stack according to which the UE of FIG. 1A communicates with base stations;

FIG. 3A is an example message sequence in which a base station transmits (i.e., via multicast or broadcast) (i) an MBS SPS configuration, and (ii) MBS data in accordance with the SPS configuration, to two UEs;

FIG. 3B is an example message sequence similar to the message sequence of FIG. 3A, but where the base station transmits a first SPS configuration to a first UE using dedicated resources for the first UE and transmits a second SPS configuration to a second UE using dedicated resources for the second UE;

FIG. 4 is example message sequence similar to the message sequence of FIG. 3A, but where the base station rebroadcasts an SPS activation command periodically based on the periodicity of the SPS;

FIG. 5 is an example message sequence in which a base station transmits an RRC message including an MBS SPS configuration and an SPS activation indication to two UEs;

FIG. 6A is an example message sequence in which a base station receives a hybrid automatic repeat request (HARQ) acknowledgement from a UE in response to an MBS SPS activation command;

FIG. 6B is an example message sequence in which a base station receives a medium access control (MAC) protocol data unit (PDU) that includes an acknowledgement from a UE in response to an MBS SPS activation command;

FIG. 7 is an example message sequence in which a base station receives a HARQ acknowledgement from a UE in response to an MBS data packet transmitted on SPS resources;

FIG. 8 is an example message sequence in which a base station transmits, to a UE, (i) an MBS SPS configuration scheduling SPS radio resources for multicasting MBS data packets, and (ii) a unicast SPS configuration scheduling SPS radio resources for transmitting unicast data packets;

FIG. 9 is an example message sequence in which a base station transmits, to a UE, (i) a first SPS activation command having a first SPS index to activate a UE to receive MBS data packets using SPS, and (ii) a second SPS activation command having a second SPS index to activate a UE to receive unicast data packets using SPS;

FIG. 10A is a flow diagram of an example method for transmitting MBS data packets to multiple UEs using SPS, which can be implemented by a base station;

FIG. 10B is a flow diagram of an example method similar to the method of FIG. 10A, but where the base station transmits particular SPS configurations to each of the multiple UEs;

FIG. 11A is a flow diagram of an example method for retransmitting an SPS activation command in response to not receiving an acknowledgement to an initial SPS activation command, which can be implemented by a base station;

FIG. 11B is a flow diagram of an example method for retransmitting an SPS activation command in response to not receiving an acknowledgement of MBS data, which can be implemented by a base station;

FIG. 12 is a flow diagram of an example method for transmitting an SPS activation command and cyclic redundancy check (CRC) to a UE, which can be implemented by a base station;

FIG. 13A is a flow diagram of an example method for formatting an SPS activation command based on whether the SPS activation command is for transmitting MBS or unicast data, which can be implemented by a base station;

FIG. 13B is a flow diagram of an example method for configuring a field of an SPS activation command based on whether the SPS activation command is for transmitting MBS or unicast data, which can be implemented by a base station;

FIG. 14 is a flow diagram of an example method for determining whether to transmit a separate SPS configuration and SPS activation command, which can be implemented by a base station;

FIG. 15A is a flow diagram of an example method for determining whether an SPS activation command enables receiving unicast or MBS data based on a CRC received with the SPS activation command, which can be implemented by a UE;

FIG. 15B is a flow diagram of an example method for determining whether an SPS activation command enables receiving unicast or MBS data based on a format of the SPS activation command, which can be implemented by a UE;

FIG. 15C is a flow diagram of an example method for determining whether an SPS activation command enables receiving unicast or MBS data based on a field value of the SPS activation command, which can be implemented by a UE;

FIG. 16 is a flow diagram of an example method for determining whether to activate receiving data in accordance with an SPS configuration based on whether the SPS configuration is for unicast or MBS, which can be implemented by a UE;

FIG. 17 is a flow diagram of an example method for managing SPS for MBS, which can be implemented by a base station; and

FIG. 18 is a flow diagram of an example method for managing SPS for MBS, which can be implemented by a UE.

### DETAILED DESCRIPTION OF THE DRAWINGS

Generally speaking, the techniques of this disclosure allow UEs to receive MBS information via radio resources allocated by a base station of a RAN. To this end, the base station can configure different radio resources in one or multiple overlapping cells to multicast or broadcast MBS data (and associated control information) and/or unicast non-MBS data (and associated control information) with one or multiple UEs on the downlink (DL). Note that “transmit” by a base station may interchangeably refer to “multicast”, “broadcast”, and/or “unicast.” The base station can also unicast MBS data (and associated control information) to a UE on a dedicated DRB for the UE. The one or more multiple UEs can transmit non-MBS data to the base station on the uplink (UL).

Accordingly, a base station of this disclosure can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

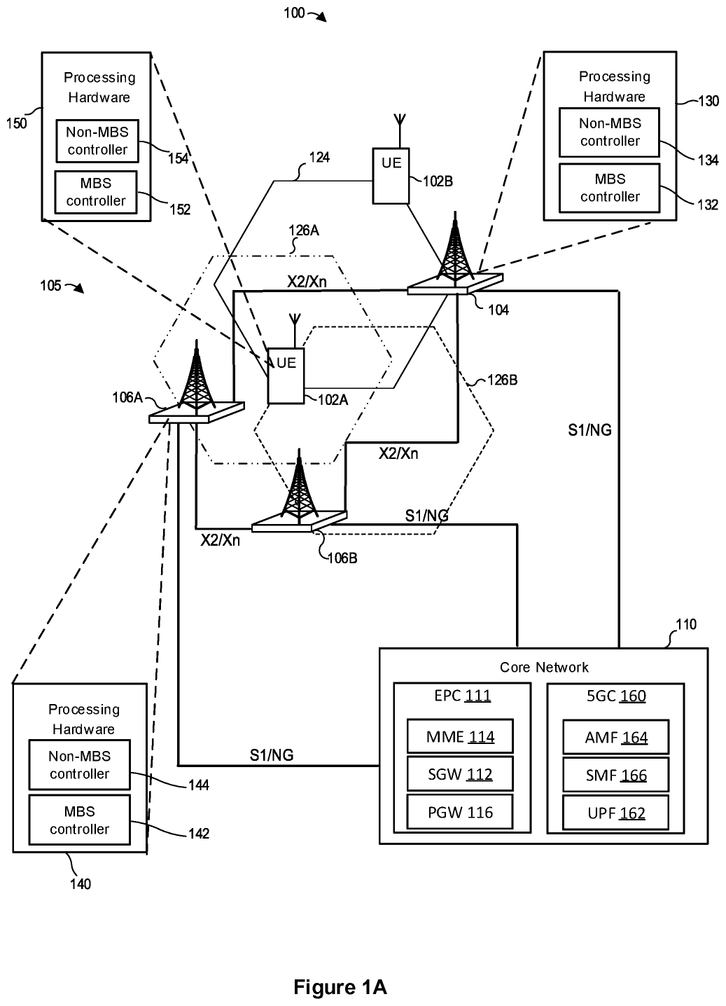

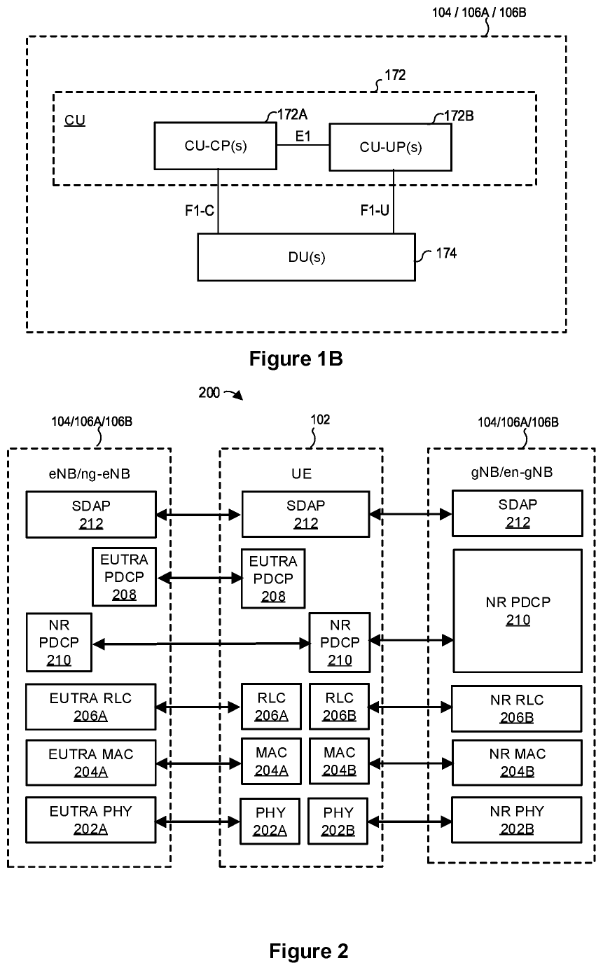

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To ease readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106A). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations, as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations, as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations, as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/1Pv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly described.

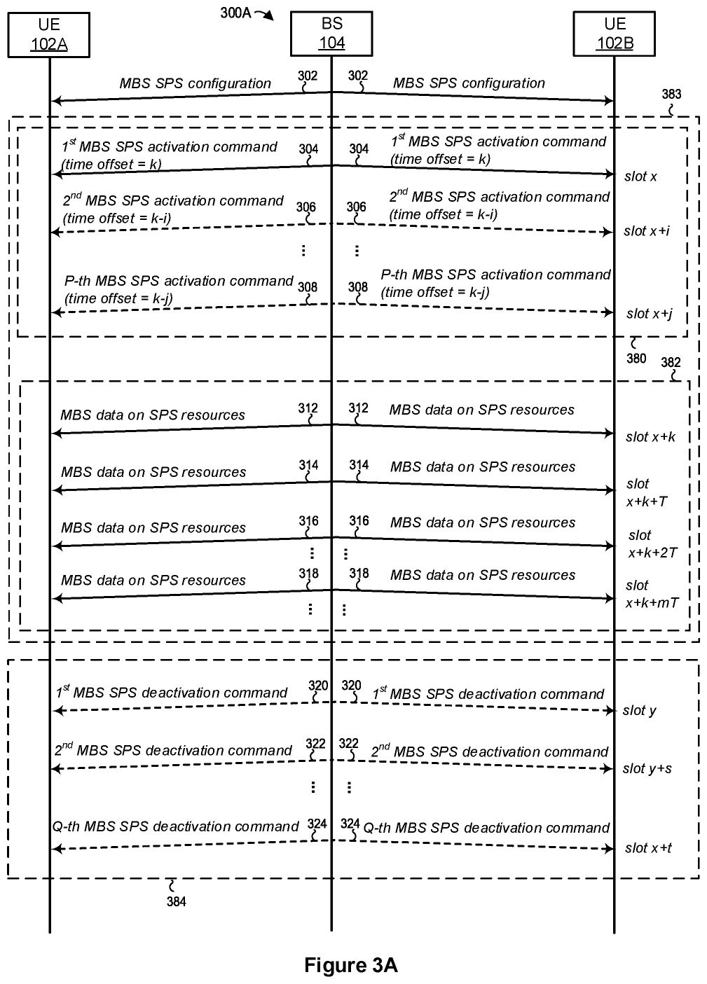

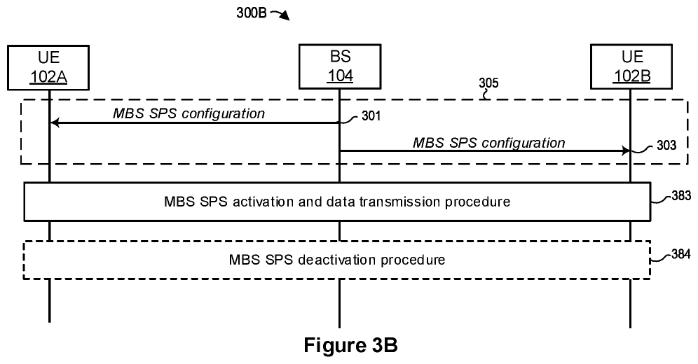

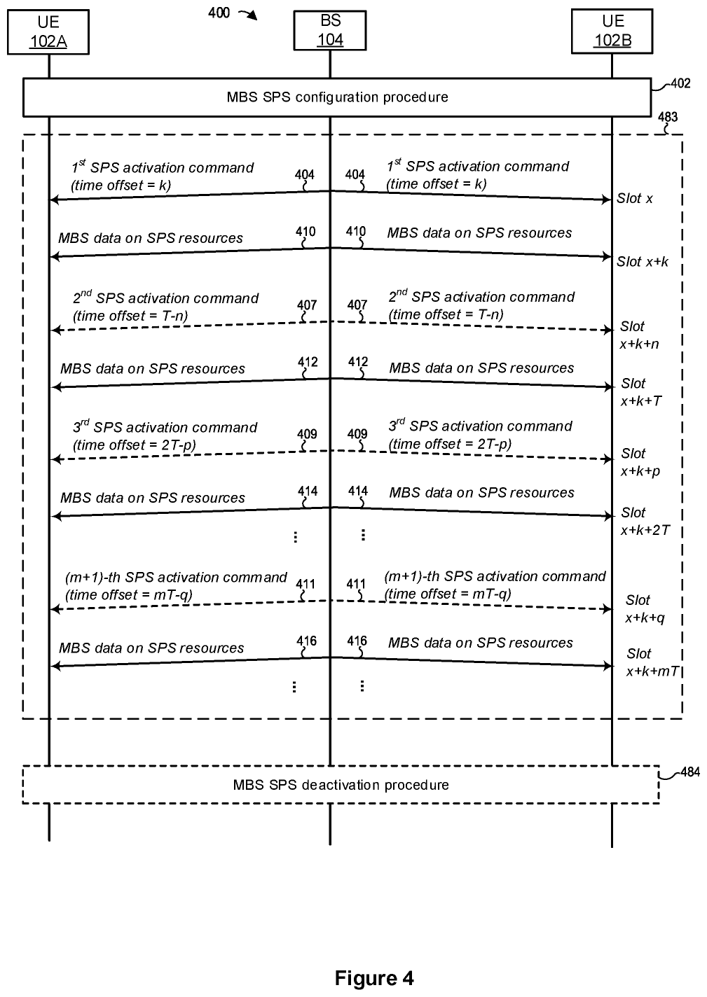

FIGS. 3A-9 are messaging diagrams of example scenarios in which one or more UEs and a base station of the RAN implement the techniques of this disclosure for managing MBS on SPS. Generally speaking, events in FIGS. 3A-9 that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Now referring to a scenario 300A illustrated in FIG. 3A, a base station 104 initially transmits (i.e., multicasts or broadcasts) 302 an MBS SPS configuration (i.e., an SPS configuration for MBS) to a UE 102A and a UE 102B. In some implementations, the base station 104 can broadcast 302 a system information block (SIB) including the MBS SPS configuration via the cell 124. In other implementations, the base station 104 can broadcast or multicast 302 an MBS-specific message including the MBS SPS configuration via the cell 124. For example, the MBS-specific message can be a Multimedia Broadcast Multicast Service (MBMS) point-to-multipoint Control Channel (MCCH) message. In some implementations, the UE 102 (i.e., the UE 102A and/or 102B) operating in an idle state or an inactive state (e.g., RRC_IDLE state, RRC_INACTIVE state) receives 302 the MBS SPS configuration from the base station 104. Alternatively, the UE 102 operating in a connected state (e.g., RRC_CONNECTED state) receives 302 the MBS SPS configuration from the base station 104.

In the MBS SPS configuration, the base station 104 can include a periodicity (e.g., 7) where SPS radio resources occur, for example. In the MBS SPS configuration, the base station 104 can also include a physical uplink control channel (PUCCH) configuration configuring radio resources for the UE 102 to transmit hybrid automatic repeat request (HARQ) acknowledgements (ACKs) or HARQ negative acknowledgements (NACKs). The base station 104 can additionally include, in the MBS SPS configuration, a physical downlink shared channel (PDSCH) configuration including configuration parameters for receiving PDSCH transmissions including MBS data on SPS resources.

After transmitting 302 the MBS SPS configuration, the base station 104 transmits one or more MBS SPS activation commands to the UE 102 to enable the UE 102 to start receiving MBS data packets. In some implementations, the MBS SPS activation commands can be DCIs. More specifically, the base station 104 at slot x can send 304 a first MBS SPS activation command (e.g., including a time offset=k) to the UE 102 to enable (i.e., activate) the UE 102 to start receiving a PDSCH transmission including MBS data on SPS resources at slot x+k. The time offset refers to a number of slots after the base station 104 transmits the MBS SPS activation command that the base station 104 will transmit MBS data. The base station 104 can send 304 the first MBS SPS activation command by unicasting the first MBS SPS activation command separately to each of the UE 102A and the UE 102B, respectively, or by broadcasting or multicasting the first MBS SPS activation command to both the UE 102A and the UE 102B.

In some implementations, the base station 104 can transmit one or more additional MBS activation commands to ensure that the UE 102 is enabled (i.e., activated) to start receiving MBS data on SPS resources at event 312. For example, the base station 104 at slot x+i (i<k) can transmit 306 a second MBS activation command (e.g., including a time offset=k−i), . . . , and/or at slot x+j (i<j<k) transmit 308 a P-th MBS activation command (e.g., including a time offset=k−j), to enable the UE 102 to start receiving MBS data on SPS resources at event 312. The value “P” can be an integer larger than 2). Other than the time offset, the second MBS SPS activation command may be the same as the first MPS SPS activation command. Said another way, the second MBS SPS activation command may be a retransmission or rebroadcast of the first MBS SPS activation command, where the time offset of the second MBS SPS activation command is shifted relative to the time offset of the first MBS SPS activation command such that both the first MBS SPS activation command and the second MBS SPS activation command refer to the same slot (slot x+k) at which the base station 104 will start transmitting MBS data. Likewise, the P-th MBS activation command may be a retransmission or rebroadcast of the first MBS SPS activation command, where the time offset of the P-th MBS activation command is shifted relative to the time offset of the first SPS activation command such that both the first MBS SPS activation command and the P-th activation command refer to the slot x+k.

After transmitting the MBS SPS activation command(s), the base station 104 transmits 312 a PDSCH transmission including MBS data on SPS resources at slot x+k, transmits 314 a PDSCH transmission including MBS data on SPS resources at slot x+k+T, transmits 316 a PDSCH transmission including MBS data on SPS resources at slot x+k+2T, . . . , transmits 318 a PDSCH transmission including MBS data on SPS resources at slot x+k+mT. The value “m” can be an integer larger than 2. The base station 104 can configure the SPS resources in the MBS SPS activation command and/or the MBS SPS configuration. In some implementations, the SPS resources include frequency resources such as physical resource blocks (PRBs). For example, the base station 104 can include a frequency domain resource assignment field in the MBS SPS activation command or the MBS SPS configuration to configure the PRBs. The base station 104 can include a time domain resource assignment field to configure the time offset in the MBS SPS activation command or the MBS SPS configuration. The base station 104 can also include configuration parameters of a modulation and coding scheme (MCS), a new data indicator (e.g., value 0), an SPS index associated with the MBS SPS configuration, a redundancy version, a PUCCH resource indicator, a transmit power control (TPC) command (e.g., for scheduled PUCCH), a virtual resource block (VRB)-to-PRB mapping, an identifier for DCI formats, and/or PDSCH-to-HARQ feedback timing indicator.

After the UE 102 receives one of the MBS SPS activation commands (e.g., the first, second, and/or third MBS SPS activation command), the UE 102 starts receiving 312 the PDSCH transmission including MBS data on SPS resources at slot x+k. Then, the UE 102 receives 314 the PDSCH transmission including MBS data on SPS resources at slot x+k+T, receives 316 the PDSCH transmission including MBS data on SPS resources at slot x+k+2T, . . . , receives 318 the PDSCH transmission including MBS data on SPS resources at slot x+k+mT.

The events 304, 306 and 308 are collectively referred to in this disclosure as an MBS SPS activation procedure 380; the events 312, 314, 316, and 318 are collectively referred to in this disclosure as an MBS SPS data transmission procedure 382; and the MBS activation procedure 380 and the MBS SPS data transmission procedure 382 are collectively referred to as an MBS SPS activation and data transmission procedure 383.

At a later time, the base station 104 can perform 384 an MBS SPS deactivation procedure to deactivate the SPS resources. In the MBS SPS deactivation procedure, the base station 104 can send 320, 322, 324 one or more MBS SPS deactivation command(s) (i.e., SPS deactivation command(s) for MBS) to the UE 102 to ensure that the UE 102 receives one of the SPS deactivation command(s). In some implementations, the base station 104 can determine to perform 384 the MBS SPS deactivation procedure if the number of UEs (i.e., the UE 102A, the UE 102B, and/or other UE(s)) to which the base station is transmitting MBS data is below a predetermined threshold. Otherwise, the base station 104 may refrain from performing an MBS SPS deactivation procedure.

In response to or after receiving one of the SPS deactivation command(s), the UE 102 deactivates the SPS resources. After deactivating the SPS resources, the UE 102 stops attempting to receive PDSCH transmissions on the SPS resources. After performing 384 the MBS SPS deactivation procedure, the base station 104 can send DCIs to schedule PDSCH transmissions including MBS data to the UE 102. More specifically, the base station 104 can unicast a particular DCI to schedule a particular PDSCH transmission including MBS data to the UE 102. The UE 102 can receive the particular DCI and attempt to receive the particular PDSCH transmission in accordance with the particular DCI. The UE 102 decodes the PDSCH transmission to obtain unicasted MBS data.

In some implementations, the base station 104 can include an inactive counter value (e.g., X) in the MBS SPS configuration. If the UE 102 consecutively detects X PDSCH transmissions are missing on the SPS resources, the UE 102 can autonomously deactivate the SPS resources. In other implementations, the base station 104 can include an inactive timer value (e.g., X) in the MBS SPS configuration. If the UE 102 consecutively detects X PDSCH transmissions are missing on the SPS resources within the inactive timer value, the UE 102 can autonomously deactivate the SPS resources. In such cases, the base station 104 may not perform an MBS SPS deactivation procedure. In some implementations, the UE 102 can detect a PDSCH transmission is missing on the SPS resource if an energy detected on the SPS resources is below a threshold. In one implementation, the base station 104 can configure a value of the threshold in the MBS SPS configuration. In another implementation, the UE 102 can determine a value of the threshold independently from the base station 104.

In some implementations, the base station 104 can (determine to) transmit the MBS SPS configuration to the UE 102 if the UE 102 supports receiving MBS on SPS resources. Otherwise, the base station 104 does not transmit an MBS SPS configuration to the UE 102.

Turning to FIG. 3B, a scenario 300B is similar to the scenario 300A, except that the base station 104 transmits a first SPS configuration to the UE 102A using dedicated resources for the UE 102A and transmits a second SPS configuration to the UE 102B using dedicated resources for the UE 102B. Instead of broadcasting or multicasting an MBS SPS configuration to the UE 102, the base station 104 unicasts 301 a first MBS SPS configuration to the UE 102A and unicasts 303 a second MBS SPS configuration to the UE 102B. The first and the second MBS SPS configurations may be the same, or at least a portion of the first and the second MBS SPS configurations may be different. For example, both the first and the second MBS configurations may indicate the same periodicity T for SPS resources, and may include the same PDSCH configuration including configuration parameters for receiving PDSCH transmissions including MBS data on SPS resources. The first and the second MBS configurations may include different PUSCH configurations configuring different radio resources for the UE 102A and the UE 102B, respectively, to use to transmit HARQ ACKs or NACKs. The events 301 and 303 are collectively referred to in this disclosure as an MBS configuration procedure 305.

After the MBS configuration procedure 305, the base station 104 performs 383 the MBS SPS activation and data transmission procedure in order to transmit MBS data to the UE 102A and the UE 102B. In some implementations, the base station 104 also performs 384 the MBS deactivation procedure to instruct the UE 102A and the UE 102B to stop receiving MBS data on the SPS resources.

Turning to FIG. 4, a scenario 400 is similar to the scenario 300A, except that the base station rebroadcasts an SPS activation command periodically based on the periodicity T of the SPS. Initially, the base station 104 performs 402 an MBS SPS configuration procedure (e.g., event 302 or 305) to transmit an MBS SPS configuration to the UE 102A and the UE 102B. The base station 104 then transmits (i.e., multicasts, broadcasts, or unicasts) 404 at slot x a first SPS activation command including a time offset=k to the UE 102 to activate the UE 102 to receive MBS data on SPS resources at slot x+k.

After transmitting 404 the first SPS activation command, the base station 104 transmits 410 a PDSCH transmission including MBS data on SPS resources at slot x+k. In some implementations, the base station 104 transmits one or more additional MBS activation commands to ensure that the UE 102 is activated to start receiving MBS data on SPS resources. In particular, the base station 104 can transmit an SPS activation command once a period. Accordingly, at slot x+k+n, where n<T, the base station 104 may transmit 407 a second SPS activation command (e.g., including a time offset=T-n) in the period after transmitting 410 the MBS data. The base station 104 can then transmit MBS data on SPS resources at slot x+k+T. The base station may also transmit 409 a third SPS activation command (e.g., including a time offset 2T−p) at slot x+k+p, where p<2T. The base station 104 then transmits 414 MBS data on SPS resources at slot x+k+2T. At slot x+k+q, the base station 104 transmits 411 an (m+1)-th SPS activation command (e.g., including a time offset=mT−q), where q<nIT. The base station 104 transmits 416 MBS data on SPS resources at slot x+k+mT. The base station 104 can continue to transmit an SPS activation command and MBS data at each period of the SPS resources. The events 404, 410, 407, 412, 409, 414, 411, and 416 are collectively referred to in this disclosure as an MBS SPS activation and data transmission procedure 483. At a later time, the base station 104 may perform 484 an MBS SPS deactivation procedure, similar to the MBS deactivation procedure 384. Although FIG. 4 shows each activation command and MBS data pair being completed prior to a transmission of a next activation command, the pairs may overlap when n is shorter than k.

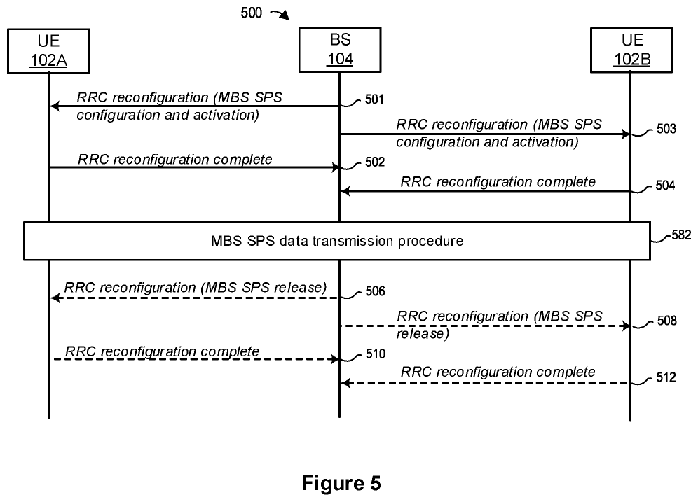

Turning to FIG. 5, in a scenario 500, a base station 104 transmits an MBS SPS configuration and an activation indication in separate RRC messages to a UE 102A and a UE 102B. Initially, the base station 104 transmits (i.e., unicasts), to the UE 102A, an RRC reconfiguration message (e.g., an RRCConnectionReconfiguration message or an RRCReconfiguration message) including a first MBS SPS configuration and an indication to activate receiving MBS data in accordance with the first MBS SPS configuration (i.e., an activation indication). In some implementations, the activation indication is included in the first MBS SPS configuration. In such implementations, the activation indication may be an information element (IE), field, or flag. Alternatively, in such implementations, the activation indication may not be an explicit indication. Rather, reception of the first MBS SPS configuration (i.e., an SPS configuration that is for receiving MBS data) implicitly instructs the UE 102A to activate receiving MBS data in accordance with the first MBS SPS configuration. In response to receiving 501 the RRC reconfiguration message, the UE 102A transmits 502 an RRC reconfiguration complete message (e.g., an RRCConnectionReconfigurationComplete message or an RRCReconfigurationComplete message) to the base station 104.

The base station 104 also transmits 503 an RRC reconfiguration message to the UE 102B including a second MBS SPS configuration and an indication to activate receiving MBS data in accordance with the second MBS SPS configuration. Similar to the first and second MBS SPS configurations discussed with reference to FIG. 3B, the first and the second MBS SPS configurations may be the same, or at least a portion of the first and the second MBS SPS configurations may be different. In response to receiving 503 the RRC reconfiguration message, the UE 102B transmits 504 an RRC reconfiguration complete message to the base station 104.

After the UEs 102A and 102B have confirmed reception of the RRC reconfiguration messages, the base station 104 performs 582 an MBS SPS data transmission procedure, similar to the MBS SPS data transmission procedure 382.

At a later time, the base station 104 may instruct the UEs 102A and 102B to stop receiving MBS data in accordance with the MBS SPS configurations. The base station 104A transmits 506, to the UE 102A, and transmits 508, to the UE 102B, an RRC reconfiguration message including an MBS SPS release indication. In response, the UE 102A and the UE 102B stop receiving MBS data in accordance with the first and second MBS SPS configurations, respectively. The UE 102A transmits 510 an RRC reconfiguration complete message to the base station 104, and, likewise, the UE 102B transmits 512 an RRC reconfiguration complete message to the base station 104.

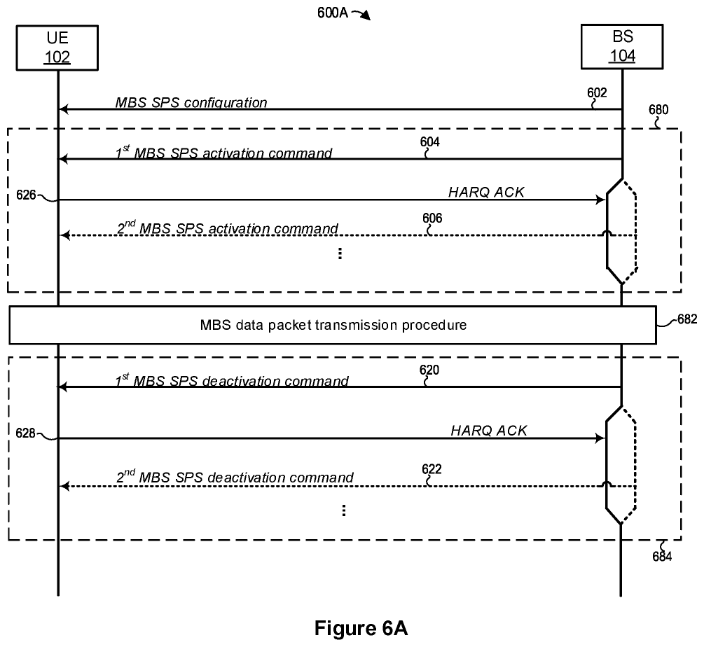

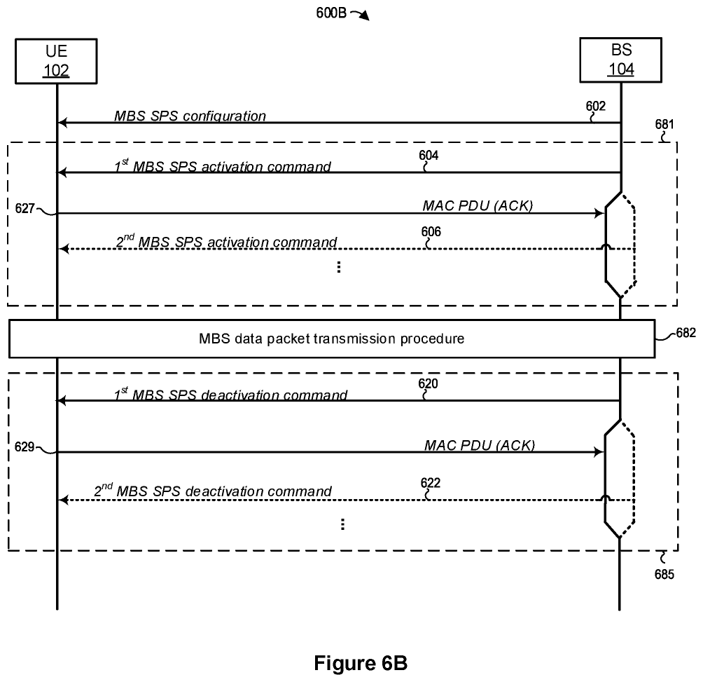

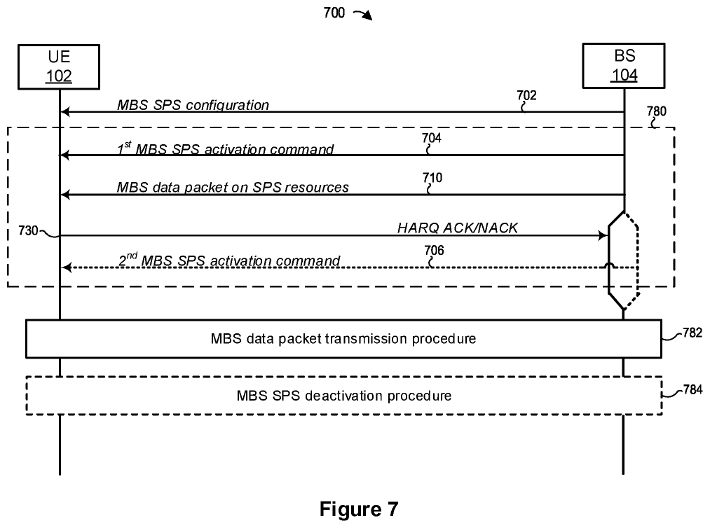

FIGS. 6A-7 illustrate feedback mechanisms that the base station 104 and the UE 102 can utilize for MBS on SPS. Turning first to FIG. 6A, a base station 104 base station receives a hybrid automatic repeat request (HARQ) acknowledgement (ACK) from a UE 102 (i.e., the UE 102A or the 102B) in response to an MBS SPS activation command. Initially, the base station 104 transmits 602 (i.e., multicasts, broadcasts, or unicasts) an MBS SPS configuration to the UE 102. At a later time, the base station transmits 604 (i.e., multicasts, broadcasts, or unicasts) a first MBS SPS activation command to the UE 102 to activate the UE 102 to receive MBS data in accordance with the MBS SPS configuration. If the UE 102 successfully receives the first MBS SPS activation command, then the UE 102 transmits 626 a HARQ ACK to the base station 104. The UE 102 can use resources indicated in the MBS SPS configuration or the first MBS SPS activation command to transmit 626 the HARQ ACK. For example, the base station 104 may transmit at least one of the MBS SPS configuration or the first MBS SPS activation command to the UE 102 via a unicast transmission. Accordingly, the at least one of the MBS SPS configuration or the first MBS SPS activation command can indicate particular resources on which the UE 102 can transmit 626 the HARQ ACK to the first MBS SPS activation command.

If the base station 104 does not receive 626 the HARQ ACK, the base station 104 can transmit 606 a second MBS SPS activation command to the UE 102, which may be the same as the first MBS SPS activation command, with the exception of a time offset. The base station 104 can continue to retransmit MBS SPS activation commands to the UE 102 until the base station 104 receives a HARQ ACK from the UE 102 or until the SPS resources on which the base station 104 is to transmit MBS data occur. The events 604, 626, and 606 are collectively referred to in this disclosure as an MBS SPS activation procedure 680.

The base station 104 can then perform 682 an MBS data packet transmission procedure, similar to the MBS data packet transmission procedure 382, to transmit MBS data to the UE 102 on SPS resources. At a later time, the base station 104 can instruct the UE 102 to stop receiving the MBS data by transmitting 620 a first SPS deactivation command to the UE 102. If the UE 102 receives 620 the first MBS SPS deactivation command, the UE 102 transmits 628 a HARQ ACK to the base station 104. Similar to the HARQ ACK the UE 102 transmits 626, the UE 102 can use resources indicated in the MBS SPS configuration or the first MBS SPS activation command to transmit 628 the HARQ ACK. In some implementations, the UE 102 can use resources indicated in at least one of the first MBS SPS deactivation command or the MBS SPS configuration to transmit 628 the HARQ ACK. If the base station 104 does not receive 628 a HARQ ACK, then the base station 104 can transmit 622 a second MBS SPS deactivation command to the UE 102 to ensure that the UE 102 receives an MBS SPS deactivation command. The base station 104 may continue to send MBS deactivation commands to the UE 102 until the base station 104 receives a HARQ ACK. The events 620, 628, and 622 are collectively referred to in this disclosure as an MBS SPS deactivation procedure 684.

FIG. 6B illustrates a scenario 600B that is generally similar to the scenario 600A, except that the UE 102 sends an ACK to an MBS SPS activation command in a MAC PDU. In particular, after successfully receiving 604 the first MBS activation command, the UE 102 transmits 627 a MAC PDU including an ACK to the first MBS SPS activation command. To transmit 627 the ACK, the UE 102 can use resources indicated in the MBS SPS configuration or the first MBS SPS activation command, or can use uplink resources configured at the UE 102 for transmitting user data to the base station 104. For example, the UE 102 can receive a first DCI from the base station 104 to assign the uplink resources. In another example, the UE 102 performs a first random access procedure with the base station 104 and receives a first random access response of the first random access procedure, including an uplink grant assigning the uplink resources. Similarly, after successfully receiving 620 the first MBS SPS deactivation command, the UE 102 transmits 629 a MAC PDU including an ACK to the first MBS deactivation command. To transmit 629 the ACK, the UE 102 can use resources indicated in the MBS SPS configuration, the first MBS SPS activation command, the first MBS SPS deactivation command, or uplink resources configured at the UE 102 for transmitting user data to the base station 104. For example, the UE 102 can receive a second DCI from the base station 104 to assign the uplink resources. In another example, the UE 102 performs a second random access procedure with the base station 104 and receives a second random access response of the second random access procedure, including an uplink grant assigning the uplink resources. The events 604, 627, and 606 are collectively referred to in this disclosure as an MBS SPS activation procedure 681, and the events 620, 629, and 622 are collectively referred to in this disclosure as an MBS SPS deactivation procedure 685.

Turning to FIG. 7, a scenario 700 is generally similar to the scenario 600A, except that the UE 102 sends a HARQ ACK or NACK to the base station 104 in response to receiving MBS data rather than an MBS activation command. The base station 104 transmits 702 an MBS SPS configuration and transmits 704 a first MBS SPS activation command to the UE 102. The base station 104 then transmits 710 an MBS data packet on SPS resources to the UE 102. If the UE 102 successfully receives 710 the MBS data packet, the UE 102 transmits 730 a HARQ ACK (i.e., a positive acknowledgement) to the base station 104. Otherwise, the UE 102 transmits 730 a HARQ NACK (i.e., a negative acknowledgement) to the base station 104. Similar to the HARQ ACK that the UE 102 transmits 626, the UE 102 can use resources indicated in the MBS SPS configuration or the first MBS SPS activation command to transmit 730 the HARQ ACK/NACK. If the base station 104 does not receive 730 the HARQ ACK/NACK, the base station 104 determines that the UE 102 did not successfully receive the first MBS SPS activation command. In response, the base station transmits 706 a second MBS SPS activation command to the UE 102, which may be the same as the first MBS SPS activation command with the exception of the time offset. The base station 104 can then perform 782 an MBS data packet transmission procedure and perform 684 an MBS SPS deactivation procedure, similar to the procedures 682 and 684, respectively.

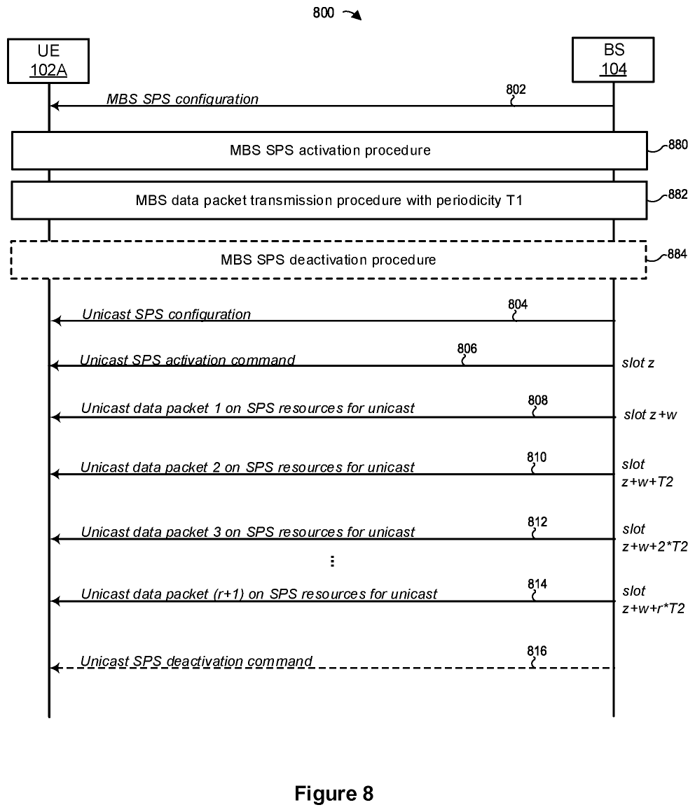

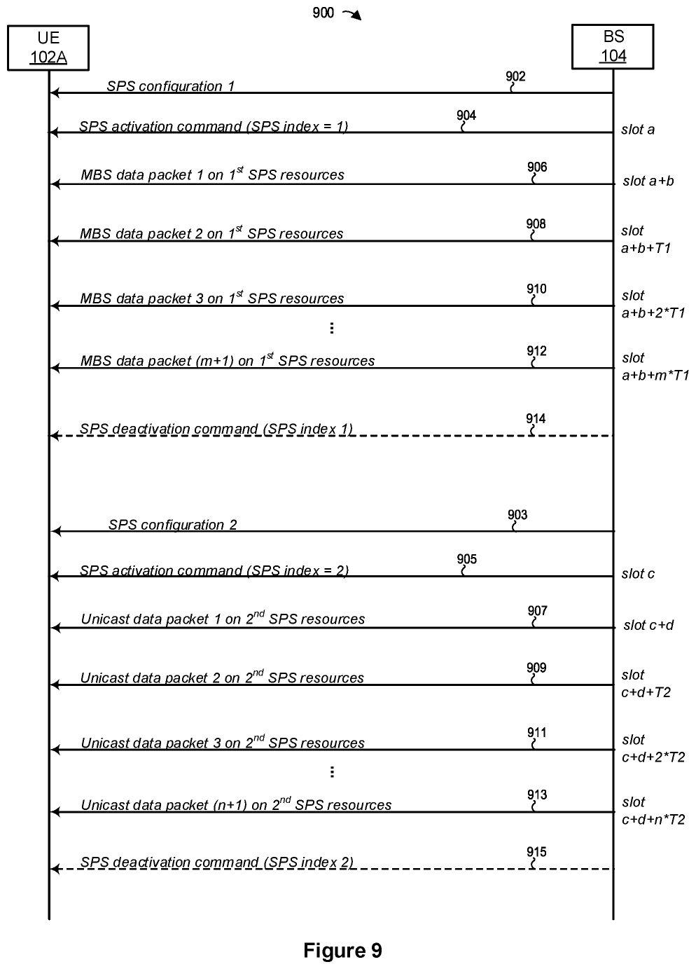

FIGS. 8-9 illustrate scenarios in which a base station 104 activates a UE 102A to receive both unicast and MBS data on SPS resources. Turning first to FIG. 8, the base station 104 transmits 802 (i.e., multicasts, broadcasts, or unicasts) an MBS SPS configuration to the UE 102A. The base station 104 performs 880 an MBS SPS activation procedure (e.g., the MBS SPS activation procedure 380, the MBS SPS activation and data transmission procedure 483, the MBS SPS activation procedure 680, the MBS SPS activation procedure 681, the MBS SPS activation procedure 780)) to activate the UE 102A to receive MBS data on SPS resources. The base station 104 performs 882 an MBS data packet transmission procedure to transmit SPS data on SPS resources in accordance with the MBS SPS configuration, where the SPS resources have a first periodicity T1 (e.g., the MBS SPS data transmission procedure 382, the MBS SPS activation and data transmission procedure 483, the MBS data packet transmission procedure 682, the MBS data packet transmission procedure 782). At a later time, the base station 104 may perform 884 an MBS SPS deactivation procedure to instruct the UE 102A to stop receiving MBS data on the SPS resources.

Before or after transmitting 802 the MBS SPS configuration to the UE 102A, the base station 104 also transmits 804 a unicast SPS configuration to the UE 102A. At slot z, the base station transmits 606 a unicast SPS activation command to the UE 102A to activate the UE 102A to receive unicast data on SPS resources in accordance with the unicast SPS configuration. The periodicity T2 for the SPS resources on which the base station 104 transmits unicast data (i.e., unicast SPS resources) may be different than the periodicity T1 for the SPS resources on which the base station 104 transmits MBS data (i.e., MBS SPS resources). The base station 104 can transmit a first data packet, a second data packet, a third data packet, . . . , and a (r+1)-th data packet on unicast SPS resources at slots z+w, z+w+T2, z+w+2*T2, . . . , and z+w+r*T2, respectively, at events 808, 810, 812, and 814. To instruct the UE 102A to stop receiving unicast data on the unicast SPS resources, the base station 104 may transmit 816 a unicast deactivation command to the UE 102A. While unicast data transmission is illustrated in FIG. 8 as occurring after the MBS data transmission, the events 810-814 may occur during the MBS data packet transmission procedure 882, for example. Thus, the base station 104 can enable the UE 102A to receive both unicast and MBS data on unicast SPS resources having a periodicity T2 and on MBS SPS resources having a periodicity T1, respectively.

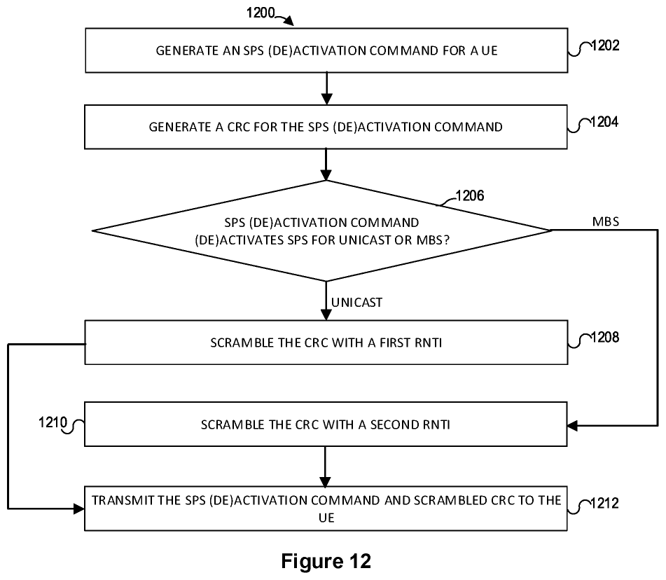

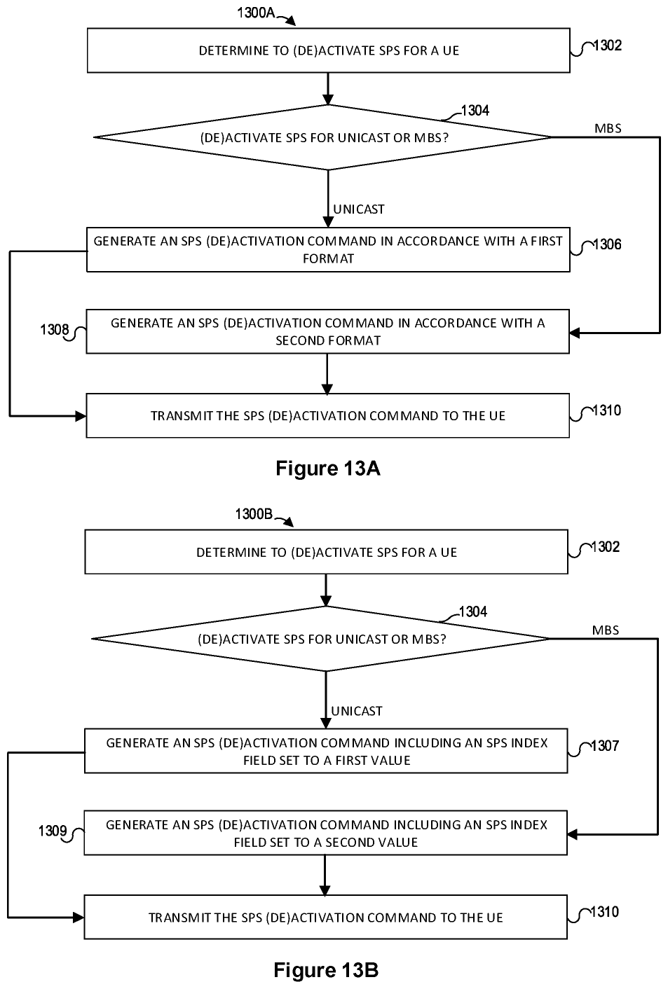

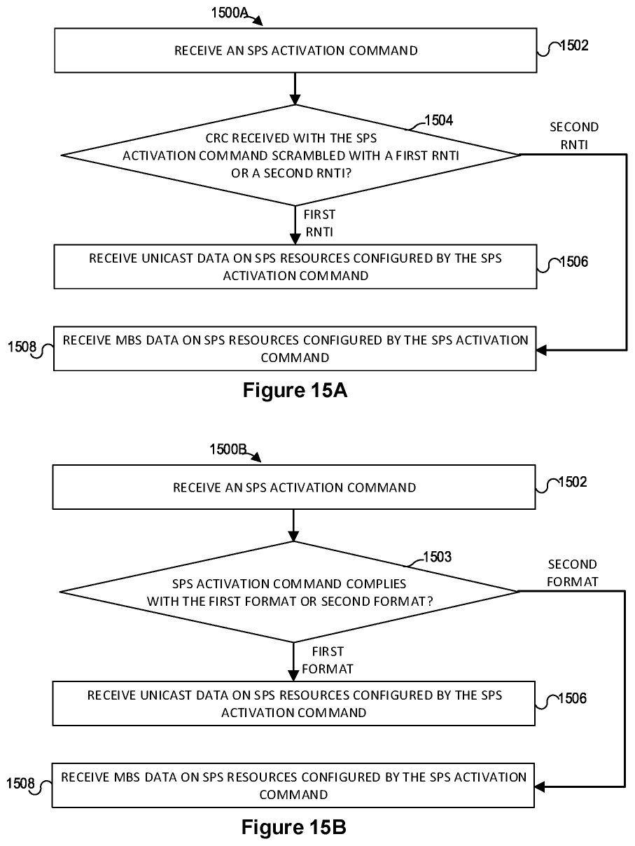

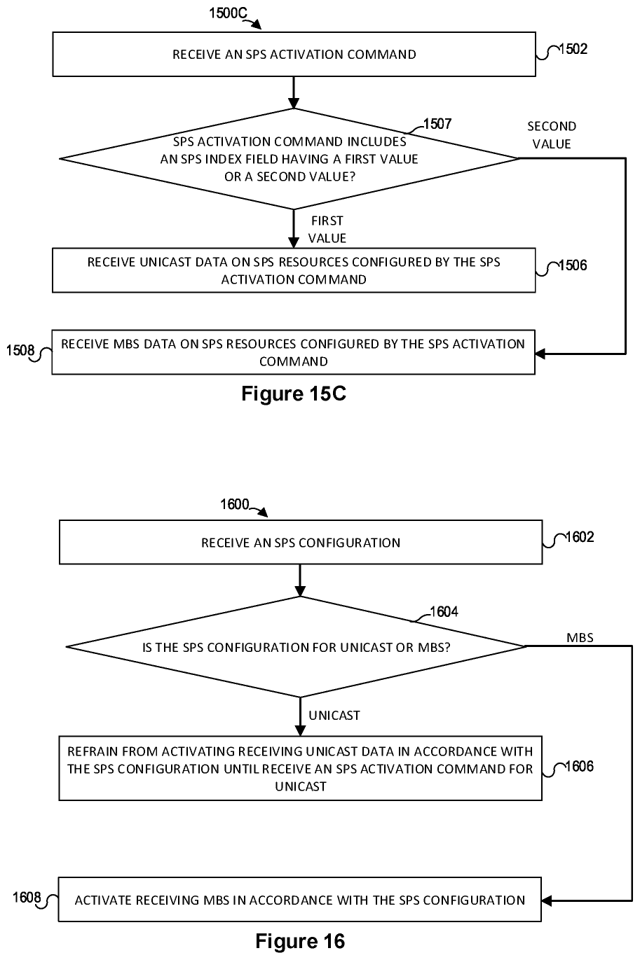

Further, the MBS SPS activation command that the base station 104 transmits during the MBS SPS activation procedure 880 and the unicast SPS activation command that the base station 104 transmits 806 may have different formats. For example, the MBS SPS activation command may be in a format specific to MBS, and the unicast SPS activation command that the base station transmits may be in a format specific to unicast. Likewise, the MBS SPS deactivation command that the base station 104 transmits during the MBS SPS deactivation procedure 884 and the unicast SPS deactivation command that the base station transmits 816 may have different formats (e.g., a format specific to MBS or a format specific to unicast). Thus, the UE 102A can identify whether an SPS activation command is for receiving unicast data or MBS data based on the format of the SPS activation command, as described below with reference to FIGS. 13A and 15B.

Additionally or alternatively, the base station 104 may use different RNTIs to transmit the MBS SPS activation command and the unicast SPS activation command. The base station 104 may use an RNTI associated with MBS (e.g., a group RNTI or an MBS-RNTI) to scramble a CRC value and transmit the scrambled CRC value with the MBS SPS activation command. Similarly, the base station may use an RNTI associated with the particular UE 102A (e.g., a C-RNTI) to scramble a CRC value for the unicast SPS activation command and transmit the scrambled CRC value with the unicast SPS activation command. Use of different RNTIs for unicast and MBS activation commands is further discussed with reference to FIGS. 12 and 15A.

FIG. 9 illustrates a scenario 900 that is similar to the scenario 800, except that the base station 104 uses an SPS index value to indicate whether SPS activation commands are for receiving unicast or MBS data. The base station 104 transmits 902 an SPS configuration 1 to the UE 102A that configures the UE 102A to receive data on first SPS resources having a periodicity T1. At slot a, the base station 104 transmits 904 an SPS activation command including an SPS index having a value equal to “1.” The SPS index value equal to 1 refers to the SPS configuration 1 (i.e., to the first SPS configuration that the UE 102A receives from the base station 104). The SPS activation command may also include a time offset equal to b. Thus, the base station 104 at slot a+b transmits 906 a first MBS data packet on first SPS resources in accordance with the SPS configuration 1, transmits 908 a second MBS data packet on the first SPS resources at slot a+b+T1, transmits 910 a third MBS data packet on the first SPS resources at slot a+b+2*T1, . . . , transmits 912 a (m+1)-th MBS data packet on the first SPS resources at slot a+b+m*T1. To instruct the UE 102A to stop receiving data on the first SPS resources, the base station 104 sends 914 an SPS deactivation command including an SPS index equal to “1” to refer to the SPS configuration 1.

Similarly, the base station 104 also transmits 903 an SPS configuration 2 to the UE 102A that configures the UE 102A to receive data on second SPS resources having a periodicity T2. At slot c, the base station 104 transmits 905 an SPS activation command including an SPS index having a value equal to “2.” The SPS index value equal to 2 refers to the SPS configuration 2 (i.e., to the second SPS configuration that the UE 102A receives from the base station 104. The SPS activation command may also include a time offset equal to d. Thus, the base station 104 at slot c+d transmits 907 a first unicast data packet on second SPS resources in accordance with the SPS configuration 2, transmits 909 a second unicast data packet on the second SPS resources at slot c+d+T2, transmits 911 a third unicast data packet on the second SPS resources at slot c+d+2*T2, . . . , transmits 913 a (n+1)-th unicast data packet on the second SPS resources at slot c+d+n*T2, to the UE 102A. To instruct the UE 102A to stop receiving data on the second SPS resources, the base station 104 sends 915 an SPS deactivation command including an SPS index equal to “2” to refer to the SPS configuration 2.

In some implementations, SPS configuration formats (e.g., IE formats) of the SPS configuration 1 and the SPS configuration 2 can be the same or different.

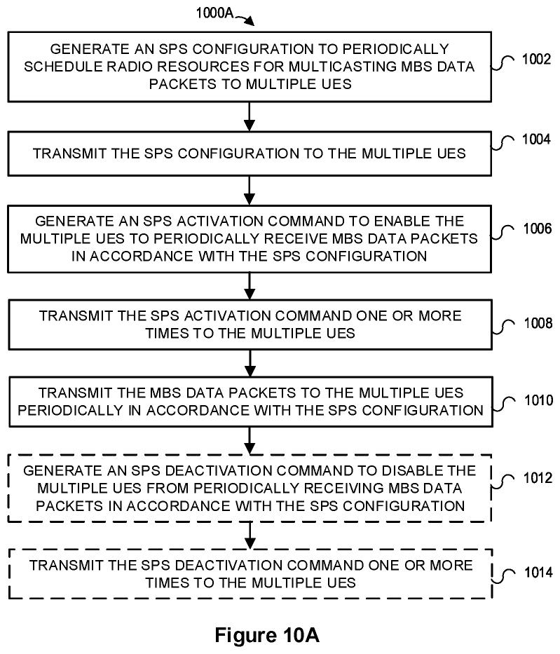

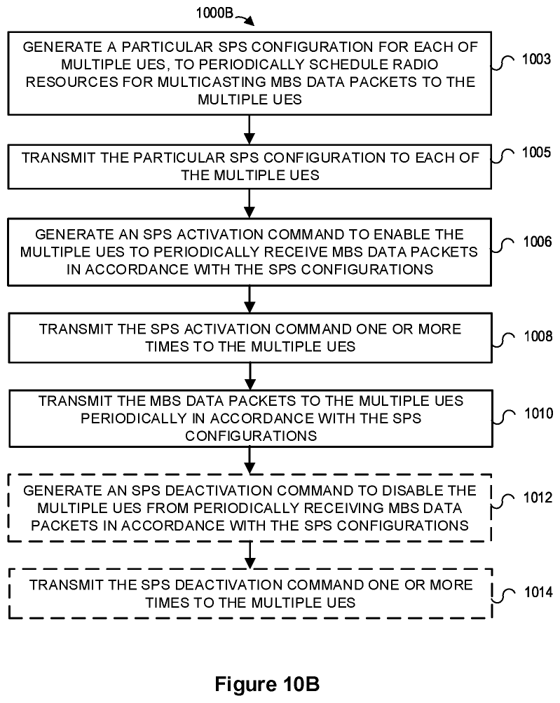

FIGS. 10A-18 are flow diagrams depicting example methods that a base station (e.g., the base station 104) of a RAN (e.g., the RAN 105) or a UE (e.g., the UE 102A or the UE 102B) can implement to manage transmission/reception of MBS on SPS.

Turning first to FIG. 10A, a base station can implement an example method 1000A to transmit MBS data packets to multiple UEs using SPS. At block 1002, the base station generates an SPS configuration to periodically schedule radio resources for multicasting MBS data packets to multiple UEs. At block 1004, the base station transmits the SPS configuration to the multiple UEs (e.g., events 302, 305, 402, 602, 702, 802, 902). Next, the base station generates an SPS activation command to enable the multiple UEs to periodically receive MBS data packets in accordance with the SPS configuration, at block 1006, and transmits the SPS activation command one or more times to the multiple UEs, at block 1008 (e.g., events 304, 306, 308, 380, 404, 407, 409, 411, 481, 604, 606, 704, 706, 880, 904). At block 1010, the base station transmits the MBS data packets to the multiple UEs periodically in accordance with the SPS configuration (e.g., 312, 314, 316, 318, 382, 380, 410, 412, 414, 416, 682, 710, 782, 882, 908, 910, 912). Next, the base station at block 1012 generates an SPS deactivation command to disable the multiple UEs from periodically receiving MBS data packets in accordance with the SPS configuration, and transmits the SPS deactivation command one or more times to the multiple UEs at block 1014 (e.g., block 320, 322, 423, 384, 484, 620, 622, 784, 884, 914).

FIG. 10B is a flow diagram of an example method 1000B that is similar to the method 1000B, but where the base station transmits particular SPS configurations to each of the multiple UEs. Blocks of FIG. 10B that are the same as blocks of FIG. 10A are labeled with the same reference numbers. At block 1003, the base station generates a particular SPS configuration for each of multiple UEs to periodically schedule radio resources for multicasting MBS data packets to the multiple UEs. At block 1005, the base station transmits the particular SPS configurations to each of the multiple UEs (e.g., event 305). The particular SPS configurations may be the same or at least a portion of the SPS configurations may be different.

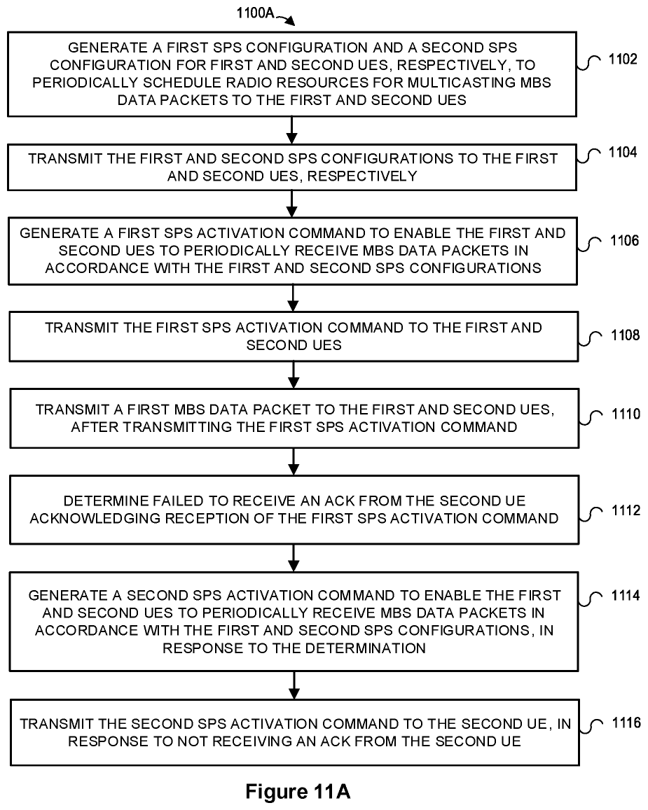

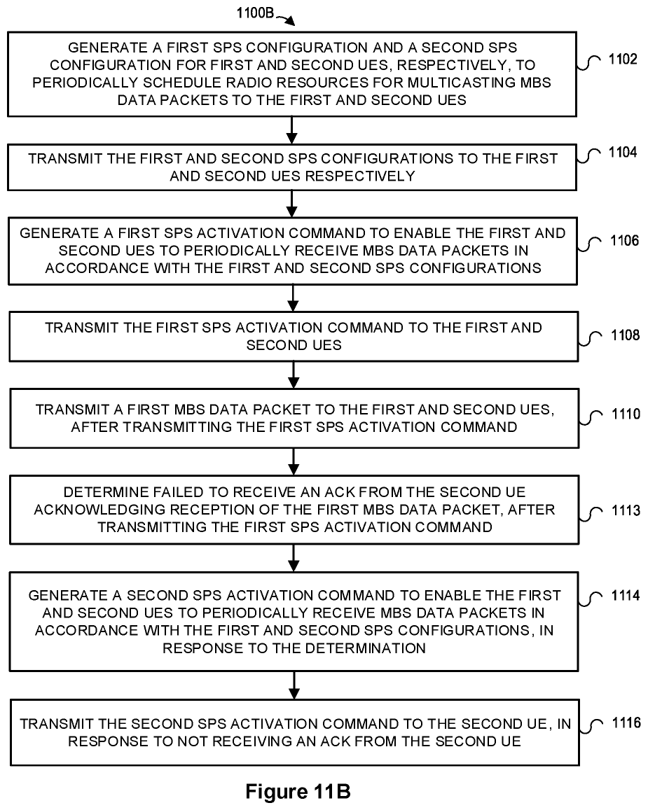

FIG. 11A is a flow diagram of an example method 1100A for retransmitting an SPS activation command in response to not receiving an acknowledgement to an initial SPS activation command, which can be implemented by a base station. At block 1102, the base station generates a first SPS configuration and a second SPS configuration for a first UE and a second UE, respectively, to periodically schedule radio resources for multicasting MBS data packets to the first and the second UEs. In some implementations, in the first and second SPS configurations, the base station assigns the first and second UEs first and second radio resources, respectively, on which to transmit an acknowledgement to an SPS activation command and/or MBS data. At block 1104, the base station transmits the first and second SPS configurations to the first and second UEs, respectively (e.g., events 305, 602). Next, the base station generates, at block 1106, a first activation command to enable the first and second UEs to periodically receive MBS data packets in accordance with the first and second SPS configurations, respectively, and transmits, at block 1108, the first SPS activation command to the first and second UEs (e.g., event 604). In some implementations, the base station unicasts the first SPS activation command to each of the first and second UEs. In other implementations, the base station multicasts or broadcasts the first SPS activation command to the first and second UEs.

At block 1110, after transmitting the first SPS activation command, the base station transmits a first MBS data packet to the first and second UEs (e.g., event 682). At block 1112, the base station determines that the base station failed to receive an acknowledgement from the second UE acknowledging reception of the first activation command (e.g., the scenario 600A in which the base station 104 does not receive 626 the HARQ ACK, or the scenario 600B in which the base station 104 does not receive 627 the MAC PDU). In response, at block 1114, the base station generates a second activation command to enable the first and second UEs to periodically receive MBS data packets in accordance with the first and second SPS configurations, respectively, and transmits, at block 1116, the second activation command to the second UE (e.g., event 606). In some implementations, the base station unicasts the second SPS activation command to the second UE. In other implementations, the base station multicasts or broadcasts the second SPS activation command to the first and second UEs.

FIG. 11B is a flow diagram of an example method 1100B that is similar to the method 1100A. However, after block 1110, the base station at block 1113 determines that the base station failed to receive an acknowledgement (positive or negative) from the second UE acknowledging reception of the first MBS data packet (e.g., the scenario 700 in which the base station 104 does not receive 730 the HARQ ACK/NACK). In response, the base station at block 1114 generates the second SPS activation command.

FIG. 12 is a flow diagram of an example method 1200 for transmitting an SPS (de)activation command and cyclic redundancy check (CRC) to a UE, which can be implemented by a base station. At block 1202, the base station generates an (de)activation command for a UE. At block 1204, the base station generates a CRC value for the SPS (de)activation command. At block 1206, the base station determines whether the SPS (de)activation command (de)activates SPS for unicast data transmission or MBS. If the SPS (de)activation command is for unicast data transmission, then at block 1208, the base station scrambles the CRC value with a first RNTI (e.g., a configured scheduling C-RNTI (CS-RNTI) for the UE) and transmits, at block 1212, the SPS (de)activation command and scrambled CRC value to the UE. If the SPS (de)activation command is for MBS, then at block 1210, the base station scrambles the CRC value with a second RNTI (e.g., a group CS-RNTI or an MBS CS-RNTI) and transmits, at block 1212, the SPS (de)activation command and scrambled CRC value to the UE.

FIG. 13A is a flow diagram of an example method 1300A for formatting an SPS (de)activation command based on whether the SPS (de)activation command is for transmitting MBS or unicast data, which can be implemented by a base station. Blocks in FIGS. 13A-13B that are the same are labeled with the same reference numbers. At block 1302, the base station determines to (de)activate SPS for a UE. At block 1304, the base station determines whether the base station is (de)activating SPS to transmit unicast data or for MBS. If the base station is (de)activating SPS for the unicast data, then the base station at block 1306 generates an SPS (de)activation command in accordance with a first format (e.g., a format specific to unicast). Otherwise, the base station at block 1308 generates an SPS (de)activation command in accordance with a second format (e.g., a format specific to MBS). At block 1310, the base station transmits the SPS (de)activation command to the UE.

FIG. 13B is a flow diagram of an example method 1300B that is similar to the method 1300A. However, if the base station determines at block 1304 to (de)activate SPS for unicast data, then the base station, at block 1307, generates an SPS (de)activation command including an index field (e.g., SPS index) set to a first value. If the base station determines at block 1304 to (de)activate SPS for MBS, then the base station, at block 1309, generates an SPS (de)activation command including an index field set to a second value. For example, the first value may refer to an SPS configuration that configures the UE to receive unicast data on SPS resources, and the second value may refer to an SPS configuration that configures the UE to receive MBS data on SPS resources. The SPS (de)activation commands that the base station generates at blocks 1307 and 1309 may have the same format, in contrast to the SPS (de)activation commands that the base station generates at blocks 1306 and 1308.

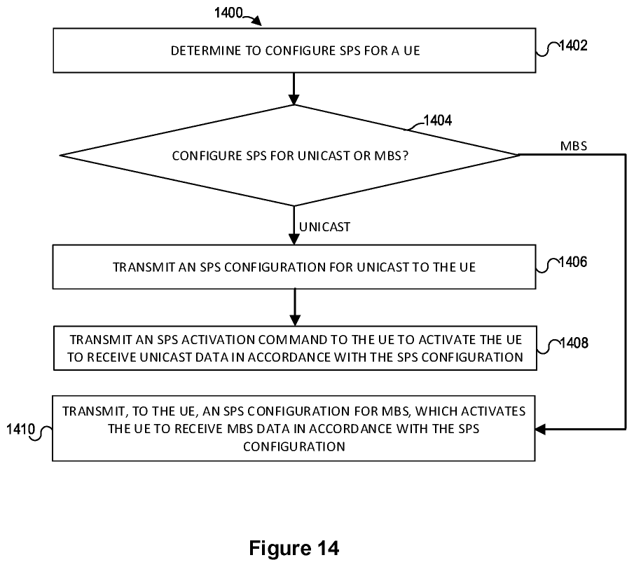

FIG. 14 is a flow diagram of an example method 1400 for determining whether to transmit a separate SPS configuration and SPS activation command, which can be implemented by a base station. At block 1402, the base station determines to configure SPS for a UE. At block 1404, the base station determines whether the base station is configuring SPS for unicast data transmission or MBS. If the base station is configuring SPS for unicast data transmission, then the base station at block 1406 transmits an SPS configuration for unicast data transmission to the UE. Next, at block 1408, the base station transmits an SPS activation command to the UE to activate the UE to receive unicast data in accordance with the SPS configuration. If the base station is configuring SPS for MBS, then the base station at block 1410 transmits, to the UE, an SPS configuration for MBS, where receiving the configuration activates the UE to receive MBS data in accordance with the SPS configuration.

FIGS. 15A-15C and FIG. 16 illustrate example methods that can be implemented by a UE. Blocks in FIGS. 15A-15C that are the same are labeled with the same reference numbers.

FIG. 15A is a flow diagram of an example method 1500A for determining whether an SPS activation command enables receiving unicast or MBS data based on a CRC received with the SPS activation command. At block 1502, the UE receives an SPS activation command. At block 1504, the UE determines whether a CRC value received with the SPS activation command has been scrambled with a first RNTI or a second RNTI. If the CRC value has been scrambled with a first RNTI (e.g., a CS-RNTI), then the UE at block 1506 receives unicast data on SPS resources configured by the SPS activation command. If the CRC value has been scrambled with a second RNTI (e.g., a group CS-RNTI or an MBS CS-RNTI), then the UE at block 1508 receives MBS data on SPS resources configured by the SPS activation command.

Later on, the UE can receive an SPS deactivation command. The UE determines whether a CRC value received with the SPS deactivation command has been scrambled with the first RNTI or the second RNTI. If the CRC value has been scrambled with the first RNTI, then the UE deactivates the SPS resources for unicast. If the CRC value has been scrambled with the second RNTI, then the UE deactivates the SPS resources for MBS.

FIG. 15B is a flow diagram of an example method 1500B, which is similar to the method 1500A. However, the UE determines whether an SPS activation command enables receiving unicast or MBS data based on a format of the SPS activation command. At block 1503, the UE determines whether an SPS activation command complies with a first format or a second format. If the SPS activation command is in a first format (e.g., a format specific to unicast), then the UE at block 1506 receives unicast data on SPS resources configured by the SPS activation command. If SPS activation command is in a second format (e.g., a format specific to MBS), then the UE at block 1508 receives MBS data on SPS resources configured by the SPS activation command.

Later on, the UE can receive an SPS deactivation command. The UE determines whether the SPS deactivation command complies with a third format or a fourth format. If the SPS deactivation command is in a third format (e.g., a format specific to unicast), then the UE deactivates the SPS resources for unicast. If SPS activation command is in a fourth format (e.g., a format specific to MBS), then the UE deactivates the SPS resources for MBS. In some implementations, the first and third formats can be the same or different, and the second and fourth formats can be the same or different.

FIG. 15C is a flow diagram of an example method 1500C, which is similar to the method 1500A. However, the UE determines whether an SPS activation command enables receiving unicast or MBS data based on a field value of the SPS activation command. At block 1507, the UE determines whether the SPS activation command includes an SPS index field having a first value or a second value. If the SPS index field is equal to a first value, then the UE at block 1506 receives unicast data on SPS resources configured by the SPS activation command. If the SPS index field is equal to a second value, then the UE at block 1508 receives MBS data on SPS resources configured by the SPS activation command.

Later on, the UE can receive an SPS deactivation command. The UE determines whether the SPS activation command includes an SPS index field having a first value or a second value. If the SPS index field is equal to the first value, then the UE deactivates the SPS resources for unicast. If the SPS index field is equal to the second value, then the UE deactivates the SPS resources for MBS.

FIG. 16 is a flow diagram of an example method 1600 for determining whether to activate receiving data in accordance with an SPS configuration based on whether the SPS configuration is for unicast or MBS. At block 1602, the UE receives an SPS configuration. At block 1604, the UE determines whether the SPS configuration is for receiving unicast data or MBS. If the SPS configuration is for receiving unicast data, then at block 1606 the UE refrains from activating receiving unicast data in accordance with the SPS configuration until the UE receives an SPS activation command for unicast. If the SPS configuration is receiving MBS, then the UE at block 1608 activates receiving MBS in accordance with the SPS configuration. The UE activates receiving MBS based on receiving the SPS configuration and does not need to receive a separate SPS activation command to activate receiving MBS.

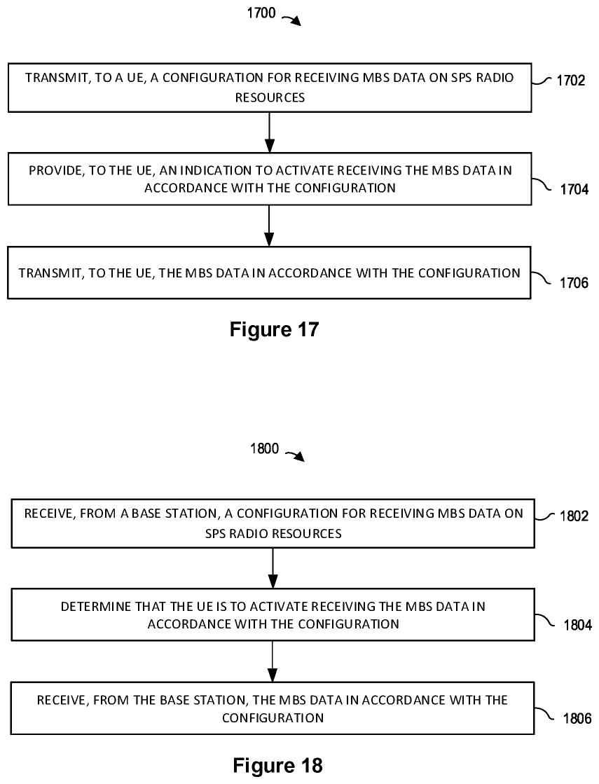

FIG. 17 is a flow diagram of an example method 1700 for managing transmission of MBS using SPS, which can be implemented by a base station. At block 1702, the base station transmits, to a UE, a configuration for receiving MBS data on SPS radio resources (e.g., an MBS SPS configuration) (e.g., events 302, 301, 303, 305, 402, 501, 503, 602, 702, 802, 902). At block 1704, the base station provides, to the UE, an indication to activate receiving the MBS data in accordance with the configuration (e.g., events 304, 380, 404, 501, 503, 604, 704, 880, 904). At block 1706, the base station transmits, to the UE, the MBS data in accordance with the configuration (e.g., events 312, 382, 380, 410, 582, 682, 782, 882, 906).

In some implementations, the indication that the base station provides may be included in the configuration (e.g., the configuration implicitly instructs the UE to activate receiving the MBS data in accordance with the configuration, or the configuration may include the indication as an information element). In other implementations, providing the indication includes transmitting a message formatted in accordance with a protocol for controlling radio resources (e.g., an RRC reconfiguration message) including the configuration and the indication.

In yet other implementations, providing the indication includes transmitting a command to activate receiving the MBS data in accordance with the configuration (e.g., an SPS activation command). The command may be a DCI. The base station may transmit the command at a first time slot, and the command may include a time offset corresponding to a number of slots after the first time slot at which the UE should receive the MBS data. In some implementations, the base station transmits one or more additional commands to the UE before transmitting the MBS data. In other implementations, the base station transmits a plurality of commands to the UE at different respective periods of the SPS radio resources.

In some implementations, the configuration is a first configuration and the command includes a second configuration for receiving the MBS data. In such implementations, transmitting the MBS data is further in accordance with at least the second configuration. For example, the second configuration may include a delta configuration that augments the first configuration.

The base station can indicate to the UE that the command is for activating receiving MBS data, rather than unicast data, for example. The base station may generate the command in accordance with a format specific to MBS and/or include an index value in the command that identifies the configuration (i.e., an index value that identifies a configuration for receiving MBS data on SPS radio resources). Additionally or alternatively, the base station can scramble a CRC value for the command with an identifier associated with MBS (e.g., a group RNTI or MBS-RNTI) and transmit the scrambled CRC value with the command.

In the configuration and/or the command, the base station may include an identifier to a resource on which the UE should transmit an acknowledgement to the command, and/or may include an identifier to a resource on which the UE should transmit an acknowledgement to the MBS data. The base station may receive the acknowledgement from the UE, where the acknowledgement can be a HARQ acknowledgement or an acknowledgement included in a MAC PDU. If the base station does not receive the acknowledgement (i.e., an acknowledgement to the command or to the MBS data), the base station can transmit a second command to activate receiving the MBS data in accordance with the configuration.

The base station may multicast or broadcast the command to a plurality of UEs including the UE, or unicast the command to the UE. Likewise, the base station may multicast or broadcast the configuration to a plurality of UEs including the UE, or unicast the configuration to the UE. In some implementations, the configuration is a first SPS configuration and the UE is a first UE. The base station can unicast the first SPS configuration and a second SPS configuration to the first UE and a second UE, respectively, where the second SPS configuration may be different from the first SPS configuration. Further, to the same UE, the base station can transmit both the first SPS configuration for receiving MBS data on first SPS resources, and a SPS second configuration for receiving unicast data on second SPS resources. The first and second SPS radio resources may have different periodicities.

Further, the base station may also transmit, to the UE, a deactivation command to instruct the UE to stop receiving the MBS data in accordance with the configuration.

FIG. 18 is a flow diagram of an example method 1800 for managing reception of MBS using SPS, which can be implemented by a UE. At block 1802, the UE receives, from a base station, a configuration for receiving MBS data on SPS radio resources (e.g., events 302, 301, 303, 305, 402, 501, 503, 602, 702, 802, 902). At block 1804, the UE determines that the UE is to activate receiving the MBS data in accordance with the configuration (e.g., events 304, 380, 404, 501, 503, 604, 704, 880, 904). At block 1806, the UE receives, from the base station, the MBS data in accordance with the configuration (e.g., events 312, 382, 380, 410, 582, 682, 782, 882, 906).

The following list of examples reflects a variety of the embodiments explicitly contemplated by the present disclosure:

Example 1. A method in a base station for managing transmission of multicast and/or broadcast services (MBS) using semi-persistent scheduling (SPS), the method comprising: transmitting, by processing hardware of the base station to a user equipment (UE), a configuration for receiving MBS data on SPS radio resources; providing, by the processing hardware to the UE, an indication to activate receiving the MBS data in accordance with the configuration; transmitting, by the processing hardware to the UE, the MBS data in accordance with the configuration.

Example 2. The method of example 1, wherein the indication is included in the configuration.

Example 3. The method of example 1, wherein providing the indication includes: providing the indication as an information element of the configuration.

Example 4. The method of example 1, wherein providing the indication includes: transmitting the indication with the configuration in a message formatted in accordance with a protocol for controlling radio resources.

Example 5. The method of example 1, wherein providing the indication includes: transmitting a command to activate receiving the MBS data in accordance with the configuration.

Example 6. The method of example 5, wherein the command is a first command, the method further comprising: transmitting, by the processing hardware to the UE after transmitting the first command and before transmitting the MBS data, a second command to activate receiving the MBS data in accordance with the configuration.

Example 7. The method of example 5, wherein the command is a first command, the method further comprising: transmitting, by the processing hardware to the UE, a plurality of commands at different respective periods of the SPS radio resources to activate receiving the MBS data in accordance with the configuration.

Example 8. The method of any one of examples 5-7, wherein: the configuration is a first configuration, the command includes a second configuration for receiving the MBS data, and transmitting the MBS data is further in accordance with at least the second configuration.

Example 9. The method of any one of examples 5-8, wherein: the base station transmits the command at a first time slot, and the command includes a time offset corresponding to a number of slots after the first time slot at which the UE should receive the MBS data.

Example 10. The method of any one of examples 5-9, wherein transmitting the command includes: transmitting a downlink control information (DCI).

Example 11. The method of any one of examples 5-10, wherein transmitting the command includes: generating the command in accordance with a format specific to MBS; and transmitting the generated command.

Example 12. The method of any one of examples 5-11, wherein transmitting the command includes: including, in the command, an index value identifying the configuration.

Example 13. The method of any one of examples 5-12, wherein transmitting the command includes: scrambling, by the processing hardware, a cyclic redundancy check (CRC) value for the command with an identifier associated with MBS; and transmitting the scrambled CRC value with the command.

Example 14. The method of any one of examples 5-13, wherein transmitting the configuration includes: including, in the configuration, an identifier to a resource on which the UE should transmit an acknowledgement to the command.

Example 15. The method of any one of examples 5-13, wherein transmitting the configuration includes: including, in the configuration, an identifier to a resource on which the UE should transmit an acknowledgement to the MBS data.

Example 16. The method of any one of examples 5-13, wherein transmitting the command includes: including, in the command, an identifier to a resource on which the UE should transmit an acknowledgement to the command.

Example 17. The method of any one of examples 5-13, wherein transmitting the command includes: including, in the command, an identifier to a resource on which the UE should transmit an acknowledgement to the MBS data.

Example 18. The method of any one of examples 14-17, further comprising: receiving, by the processing hardware, the acknowledgement from the UE, wherein the acknowledgement is a hybrid automatic repeat request (HARQ) acknowledgement.

Example 19. The method of any one of examples 14-17, further comprising: receiving, by the processing hardware, the acknowledgement from the UE in a medium access control (MAC) protocol data unit (PDU).

Example 20. The method of any one of examples 14-17, wherein the command is a first command, the method further comprising: in response to not receiving the acknowledgement at the resource, transmitting, by the processing hardware, a second command to activate receiving the MBS data in accordance with the configuration.

Example 21. The method of any one of examples 5-20, wherein transmitting the command includes: multicasting or broadcasting the command to a plurality of UEs including the UE.

Example 22. The method of any one of examples 5-20, wherein transmitting the command includes: unicasting the command to the UE.

Example 23. The method of any one of the preceding examples, wherein transmitting the configuration includes: multicasting or broadcasting the configuration to a plurality of UEs including the UE.

Example 24. The method of any one of the preceding examples, wherein transmitting the configuration includes: unicasting the configuration to the UE.

Example 25. The method of example 24, wherein the UE is a first UE and the configuration is a first SPS configuration, the method further comprising: unicasting, by the processing hardware to a second UE, a second SPS configuration for receiving MBS data on the SPS radio resources, wherein the second SPS configuration is different from the first SPS configuration.

Example 26. The method of any one of examples 1-24, wherein the configuration is a first SPS configuration and the SPS radio resources are first SPS radio resources, the method further comprising: transmitting, by the processing hardware to the UE, a second SPS configuration for receiving unicast data on second SPS radio resources.

Example 27. The method of example 26, wherein the first and the second SPS radio resources have different periodicities.

Example 28. The method of any one of the preceding examples, further comprising: transmitting, by the processing hardware, a deactivation command to instruct the UE to stop receiving the MBS data in accordance with the configuration.

Example 29. A base station including processing hardware and configured to implement a method according to any one of the preceding examples.

Example 30. A method in a user equipment (UE) for managing reception of multicast and/or broadcast services (MBS) using semi-persistent scheduling (SPS), the method comprising: receiving, by processing hardware of the UE from a base station, a configuration for receiving MBS data on SPS radio resources; determining, by the processing hardware, that the UE is to activate receiving the MBS data in accordance with the configuration; receiving, by the processing hardware from the base station, the MBS data in accordance with the configuration.

Example 31. The method of example 30, wherein the determining is in response to the configuration.

Example 32. The method of example 30, wherein the determining is in response to an information element included in the configuration.

Example 33. The method of example 30, wherein the determining includes: receiving a message including the configuration and an indication to activate receiving the MBS data in accordance with the configuration, the message formatted in accordance with a protocol for controlling radio resources; and determining to activate receiving the MBS data in accordance with the configuration in response to the indication.

Example 34. The method of example 30, further comprising: receiving, by the processing hardware, a command to activate receiving the MBS data in accordance with the configuration, wherein the determining is in response to the command.

Example 35. The method of example 34, wherein: the configuration is a first configuration; the command includes a second configuration for receiving the MBS data, and receiving the MBS data is further in accordance with at least the second configuration.

Example 36. The method of example 34 or 35, wherein: the UE receives the command at a first time slot, and the command includes a time offset corresponding to a number of slots after the first time slot at which the UE should receive the MBS data.

Example 37. The method of any one of examples 34-36, wherein receiving the command includes: receiving a downlink control information (DCI).

Example 38. The method of any one of examples 34-37, wherein receiving the command includes: determining that the command is formatted in accordance with a format specific to MBS; and based on the format, determining that the command activates receiving the MBS data in accordance with the configuration.

Example 39. The method of any one of examples 34-37, wherein receiving the command includes: determining that the command includes an index value identifying the configuration; and based on the index value, determining that the command activates receiving the MBS data in accordance with the configuration.

Example 40. The method of any one of examples 34-39, wherein receiving the command includes: descrambling a cyclic redundancy check (CRC) value received with the command using an identifier associated with MBS.

Example 41. The method of any one of examples 34-40, wherein the configuration or the command includes an identifier to a resource on which the UE should transmit an acknowledgement to the command, the method further comprising: in response to receiving the command, transmitting, by the processing hardware to the base station on the resource, a positive acknowledgement to the command.

Example 42. The method of any one of examples 34-40, wherein the configuration or the command includes an identifier to a resource on which the UE should transmit an acknowledgement to the MBS data, the method further comprising: in response to receiving the MBS data, transmitting, by the processing hardware to the base station on the resource, a positive acknowledgement to the MBS data.

Example 43. The method of example 41 or 42, wherein transmitting the positive acknowledgement includes: transmitting a hybrid automatic repeat request (HARQ) acknowledgement.

Example 44. The method of example 41 or 42, wherein transmitting the positive acknowledgement includes: transmitting the positive acknowledgement in a medium access control (MAC) protocol data unit (PDU).

Example 45. The method of any one of examples 30-44, wherein the configuration is a first SPS configuration and the SPS radio resources are first SPS radio resources, the method further comprising: receiving, by the processing hardware from the base station, a second SPS configuration for receiving unicast data on second SPS radio resources.

Example 46. The method of example 45, where the first and the second SPS radio resources have different periodicities.

Example 47. The method of any one of examples 30-46, further comprising: receiving, by the processing hardware from the base station, a deactivation command instructing the UE to stop receiving the MBS data in accordance with the configuration.

Example 48. A user equipment (UE) including processing hardware and configured to implement a method according to any one of examples 30-47.

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a base station for managing transmission of multicast and/or broadcast services (MBS) using semi-persistent scheduling (SPS), the method comprising:
unicasting, by processing hardware of the base station to a user equipment (UE), a configuration for receiving MBS data on SPS radio resources;
providing, by the processing hardware to the UE, an indication to activate receiving the MBS data in accordance with the configuration;
transmitting, by the processing hardware to the UE, the MBS data in accordance with the configuration.

2. The method of claim 1, providing the indication includes at least one of:
providing the indication as an information element of the configuration; or
transmitting the indication with the configuration in a message formatted in accordance with a protocol for controlling radio resources.

3. The method of claim 1, wherein providing the indication includes:
transmitting a command to activate receiving the MBS data in accordance with the configuration.

4. The method of claim 3, wherein the command is a first command, the method further comprising:
transmitting, by the processing hardware to the UE after transmitting the first command and before transmitting the MBS data, a second command to activate receiving the MBS data in accordance with the configuration.

5. The method of claim 3, wherein the command is a first command, the method further comprising:
transmitting, by the processing hardware to the UE, a plurality of commands at different respective periods of the SPS radio resources to activate receiving the MBS data in accordance with the configuration.

6. The method of any one of claims 3-5, wherein:
the base station transmits the command at a first time slot, and
the command includes a time offset corresponding to a number of slots after the first time slot at which the UE should receive the MBS data.

7. The method of any one of claims 3-6, wherein transmitting the configuration includes:
including, in the configuration, (i) an identifier to a resource on which the UE should transmit an acknowledgement to the command and (ii) a Physical Uplink Control Channel (PUCCH) resource indicator in the command.

8. The method of any one of claims 3-7, wherein transmitting the configuration includes:
including, in the configuration, an identifier for downlink control information (DCI) formats.

9. The method of any one of claims 3-8, wherein transmitting the command includes:
including, in the command, at least one of a frequency domain resource assignment field, a time domain resource assignment field, a modulation and coding scheme (MCS), a new data indicator, a redundancy version, a virtual resource block (VRB)-to-physical resource block (PRB) mapping, or a Physical Downlink Shared Channel (PDSCH)-to-hybrid automatic repeat request (HARQ) feedback timing indicator.

10. The method of any one of the preceding claims, wherein the UE is a first UE and the configuration is a first SPS configuration, the method further comprising:
unicasting, by the processing hardware to a second UE, a second SPS configuration for receiving MBS data on the SPS radio resources, wherein the second SPS configuration is different from the first SPS configuration.

11. The method of any one of claims 1-9, wherein the configuration is a first SPS configuration and the SPS radio resources are first SPS radio resources, the method further comprising:
transmitting, by the processing hardware to the UE, a second SPS configuration for receiving unicast data on second SPS radio resources.

12. A base station including processing hardware and configured to implement a method according to any one of the preceding claims.

13. A method in a user equipment (UE) for managing reception of multicast and/or broadcast services (MBS) using semi-persistent scheduling (SPS), the method comprising:
receiving, by processing hardware of the UE from a base station on resources dedicated for the UE, a configuration for receiving MBS data on SPS radio resources;
determining, by the processing hardware, that the UE is to activate receiving the MBS data in accordance with the configuration;
receiving, by the processing hardware from the base station, the MBS data in accordance with the configuration.

14. The method of claim 13, wherein the determining includes at least one of:
(i) determining that the UE is activate receiving the MBS data in response to an information element included in the configuration; or
(ii) receiving a message including the configuration and an indication to activate receiving the MBS data in accordance with the configuration, the message formatted in accordance with a protocol for controlling radio resources; and determining to activate receiving the MBS data in accordance with the configuration in response to the indication.

15. The method of claim 13, further comprising:
receiving, by the processing hardware, a command to activate receiving the MBS data in accordance with the configuration,
wherein the determining is in response to the command.

16. The method of claim 15, wherein the configuration includes (i) an identifier to a resource on which the UE should transmit an acknowledgement to the command and (ii) a Physical Uplink Control Channel (PUCCH) resource indicator in the command, the method further comprising:
in response to receiving the command, transmitting, by the processing hardware to the base station on the resource, a positive acknowledgement to the command.

17. The method of claim 15 or 16, wherein the configuration includes an identifier for downlink control information (DCI) formats.

18. The method of any one of claims 15-17, wherein the command includes at least one of a frequency domain resource assignment field, a time domain resource assignment field, a modulation and coding scheme (MCS), a new data indicator, a redundancy version, a virtual resource block (VRB)-to-physical resource block (PRB) mapping, or a Physical Downlink Shared Channel (PDSCH)-to-hybrid automatic repeat request (HARQ) feedback timing indicator.

19. The method of any one of claims 13-18, wherein the configuration is a first SPS configuration and the SPS radio resources are first SPS radio resources, the method further comprising:
receiving, by the processing hardware from the base station, a second SPS configuration for receiving unicast data on second SPS radio resources.

20. A user equipment (UE) including processing hardware and configured to implement a method according to any one of claims 13-19.
